(19) United States
(12) Patent Application Publication
(10) Pub. No.: US 2021/0304302 A1
(43) Pub. Date: Sep. 30, 2021

(54) SYSTEM AND METHOD FOR GENERATING TAILORED DIMINUTIVE FUNCTIONS TO FACILITATE RESOURCE INTERACTIONS

(71) Applicant: BANK OF AMERICA CORPORATION, Charlotte, NC (US)

(72) Inventors: Katherine Dintenfass, Lincoln, RI (US); Leslie Richard Rhyne, Bend, OR (US); Evelyn Varner, Hopkinton, MA (US)

(73) Assignee: BANK OF AMERICA CORPORATION, Charlotte, NC (US)

(21) Appl. No.: 16/832,355

(22) Filed: Mar. 27, 2020

(51) Int. Cl. G06Q 40/02; G06Q 20/24; G06Q 20/26

(52) U.S. Cl. CPC G06Q 40/02; G06Q 20/26; G06Q 20/24

(57) ABSTRACT

Embodiments of the present invention provide a system for generating tailored diminutive functions to facilitate resource interactions. The system is configured for identifying a target associated with a user based on accessing user information from an entity system, generating tailored diminutive functions associated with the target, integrating the tailored diminutive functions into an entity application stored on a user device of the user, displaying functionalities associated with the tailored diminutive functions on a user interface of the user device, and causing the entity application to prompt the user to complete an interaction associated with a functionality of the functionalities.

### BACKGROUND

Conventional systems do not have the ability to effectively engage resource interactions. As such, there exists a need for a system to generate tailored diminutive functions to engage and facilitate resource interactions.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for generating tailored diminutive functions to facilitate resource interactions. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention identifies a target associated with a user based on accessing user information from an entity system, generates tailored diminutive functions associated with the target, and integrates the tailored diminutive functions into an entity application stored on a user device of the user.

In some embodiments, the present invention in response to integrating the tailored diminutive functions into the entity application, displays functionalities associated with the tailored diminutive functions on a user interface of the user device and causes the entity application to prompt the user to complete an interaction associated with a functionality of the functionalities.

In some embodiments, the present invention determines that the user has completed the interaction associated with the functionality and prompts the user to complete at least one other interaction associated with the functionality.

In some embodiments, the present invention in response to determining that the user has completed the at least one interaction, categorizes the user in real-time and assign a tier status to the user and pushes real-time resource functionalities associated with the tier status to a user account stored in the entity application.

In some embodiments, the present invention determines that the user has completed all interactions associated with the functionalities, generates new tailored diminutive functions associated with the target, and integrates the new tailored diminutive functions into the entity application.

In some embodiments, the present invention generates the tailored diminutive functions based on retrieving resource data associated with the user from the entity system, retrieving third party data associated with the user, and formulating diminutive functions based on predictive analysis.

In some embodiments, generating the tailored diminutive functions is based on an input received from an associate.

In some embodiments, the target is associated with an event or a priority of the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for generating tailored diminutive functions to facilitate resource interactions, in accordance with an embodiment of the invention;

FIG. 2 provides a block diagram illustrating the entity system 200 of FIG. 1, in accordance with an embodiment of the invention;

FIG. 3 provides a block diagram illustrating a resource interaction facilitation system 300 of FIG. 1, in accordance with an embodiment of the invention;

FIG. 4 provides a block diagram illustrating the computing device system 400 of FIG. 1, in accordance with an embodiment of the invention; and

FIG. 5 provides a flowchart illustrating a process flow for generating tailored diminutive functions to facilitate resource interactions, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “entity” may include any organization that processes financial transactions including, but not limited to, banks, credit unions, savings and loan associations, investment companies, stock brokerages, insurance companies and the like. In accordance with embodiments of the invention, the terms “third party system” and “other third party systems” may include any organizations including, but not limited to, photo identification issuing agencies, network managing organizations, email managing organizations, banks, credit unions, savings and loan associations, investment companies, stock brokerages, management firms, insurance companies, and/or the like. Furthermore, embodiments of the present invention use the term “user” or “customer.” It will be appreciated by someone with ordinary skill in the art that the user or customer may be a customer of the financial institution or a potential customer of the financial institution or an employee of the financial institution.

In accordance with embodiments of the invention, a “resource pool” or an “account” is the relationship that a customer has with an entity, such as a financial institution. Examples of accounts include a deposit account, such as a transactional account (e.g., a banking account), a savings account, an investment account, a money market account, a time deposit, a demand deposit, a pre-paid account, a credit account, a debit/deposit account, or the like. The account is associated with and/or maintained by the entity.

In accordance with embodiments of the invention, a “resource interaction” or an “interaction” may be any action performed by the user to move a step closer to achieving a goal that is associated with life priority or life event. In some embodiments, goal may be chosen by the user. In some embodiments, goal may be suggested by the system based on resource data and user data. Goals associated with life priorities may be associated with categories including but not limited to “Home,” “Finance,” “Health,” “Giving,” “Leisure,” “Family,” and “Work.” Goals associated with life events may be associated with categories including but not limited to “job change,” “marriage/divorce,” “welcome a child,” “buy/sell home,” “upcoming travel,” “retirement,” “end of life,” and/or the like.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

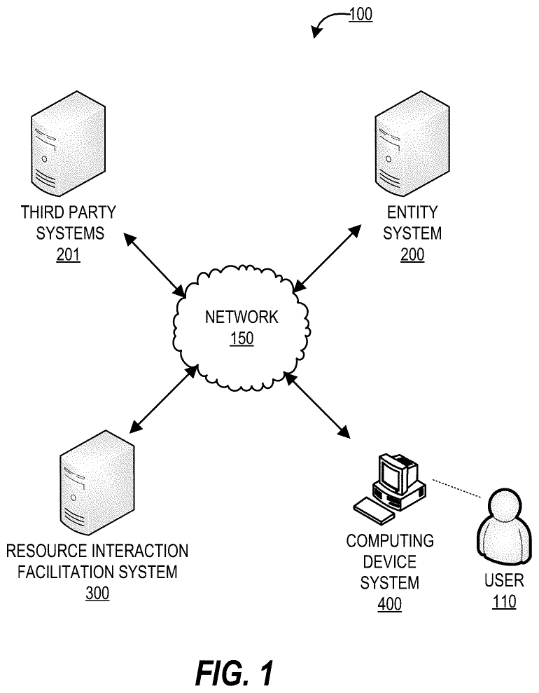

FIG. 1 provides a block diagram illustrating a system environment 100 for generating tailored diminutive functions to facilitate resource interactions, in accordance with an embodiment of the invention. As illustrated in FIG. 1, the environment 100 includes a resource interaction facilitation system 300, entity system 200, a computing device system 400, and third party systems 201. One or more users 110 may be included in the system environment 100, where the users 110 interact with the other entities of the system environment 100 via a user interface of the computing device system 400. In some embodiments, the one or more user(s) 110 of the system environment 100 may be customers and/or potential customers of an entity associated with the entity system 200. In some other embodiments, the one or more users 110 may be employees of the entity.

The entity system(s) 200 may be any system owned or otherwise controlled by an entity to support or perform one or more process steps described herein. In some embodiments, the managing entity is a financial institution. In some embodiments, the entity system 200 may include one or more servers.

Third party systems 201 may be any systems that provide any third party information to the entity system. In some embodiments, the third party systems 201 may be any systems associated with third parties that have partnered with the entity. In such embodiments, third party may be any entity that provides goods or services to the users.

The resource interaction facilitation system 300 is a system of the present invention for performing one or more process steps described herein. In some embodiments, the resource interaction facilitation system 300 may be an independent system. In some embodiments, the resource interaction facilitation system 300 may be a part of the entity system 200.

The resource interaction facilitation system 300, the entity system 200, the computing device system 400, and/or the third party systems 201 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the resource interaction facilitation system 300 is configured to communicate information or instructions with the entity system 200, the computing device system 400, and/or the third party systems 201 across the network 150.

The computing device system 400 may be a system owned or controlled by the entity of the entity system 200, the user 110, and/or a third party. As such, the computing device system 400 may be a computing device of the user 110. In general, the computing device system 400 communicates with the user 110 via a user interface of the computing device system 400, and in turn is configured to communicate information or instructions with the resource interaction facilitation system 300, entity system 200, and/or the third party systems 201 across the network 150.

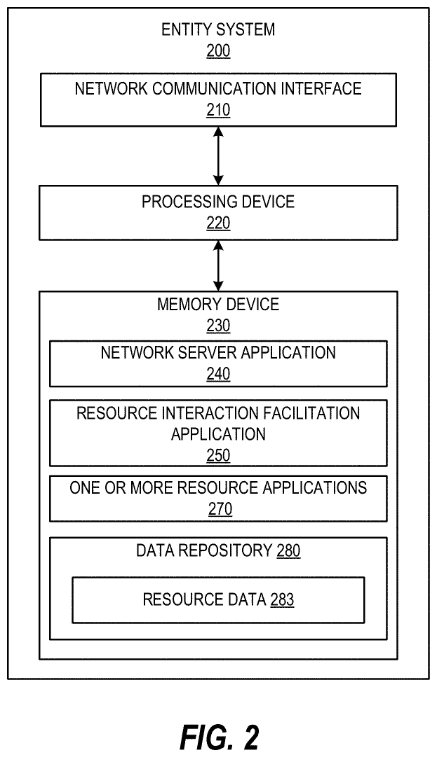

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a resource interaction facilitation application 250, one or more resource applications 270, and a data repository 280 comprising resource data 283. The computer-executable program code of the network server application 240, the resource interaction facilitation application 250, the one or more resource applications 270, to perform certain logic, data-extraction, and data-storing functions of the entity system 200 described herein, as well as communication functions of the entity system 200.

The network server application 240, the resource interaction facilitation application 250, the one or more resource applications 270, are configured to store data in the data repository 280 or to use the data stored in the data repository 280 when communicating through the network communication interface 210 with the resource interaction facilitation system 300, the computing device system 400, and/or the third party systems 201 to perform one or more process steps described herein. In some embodiments, the entity system 200 may receive instructions from the resource interaction facilitation system 300 via the resource interaction facilitation application 250 to perform certain operations. The resource interaction facilitation application 250 may be provided by the resource interaction facilitation system 300. The one or more resource applications 270 may be any of the applications used, created, modified, and/or managed by the entity system 200.

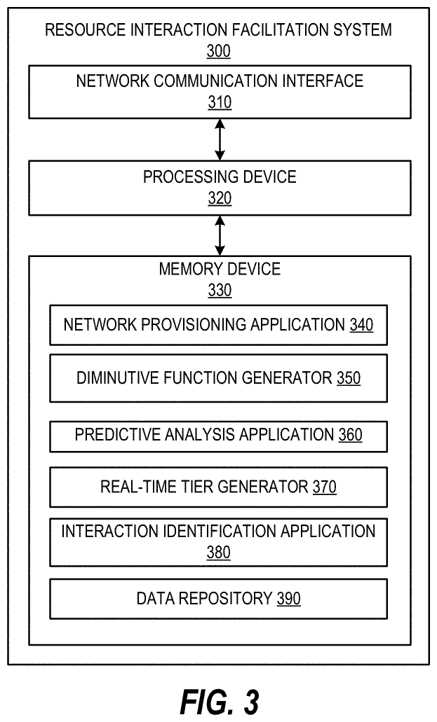

FIG. 3 provides a block diagram illustrating the resource interaction facilitation system 300 in greater detail, in accordance with embodiments of the invention. As illustrated in FIG. 3, in one embodiment of the invention, the resource interaction facilitation system 300 includes one or more processing devices 320 operatively coupled to a network communication interface 310 and a memory device 330. In certain embodiments, the resource interaction facilitation system 300 is operated by a first entity, such as a financial institution, while in other embodiments, the resource interaction facilitation system 300 is operated by an entity other than a financial institution. In some embodiments, the resource interaction facilitation system 300 is owned or operated by the entity of the entity system 200. In some embodiments, the resource interaction facilitation system 300 may be an independent system. In alternate embodiments, the resource interaction facilitation system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the resource interaction facilitation system 300 described herein. For example, in one embodiment of the resource interaction facilitation system 300, the memory device 330 includes, but is not limited to, a network provisioning application 340, a diminutive function generator 350, a predictive analysis application 360, a real-time tier generator 370, an interaction identification application 380, and a data repository 390 comprising data processed or accessed by one or more applications in the memory device 330. The computer-executable program code of the network provisioning application 340, the diminutive function generator 350, the predictive analysis application 360, the real-time tier generator 370, and the interaction identification application 380, may instruct the processing device 320 to perform certain logic, data-processing, and data-storing functions of the resource interaction facilitation system 300 described herein, as well as communication functions of the resource interaction facilitation system 300.

The network provisioning application 340, the diminutive function generator 350, the predictive analysis application 360, the real-time tier generator 370, and the interaction identification application 380 are configured to invoke or use the data in the data repository 390 when communicating through the network communication interface 310 with the entity system 200, the computing device system 400, and/or the third party systems 201. In some embodiments, the network provisioning application 340, the diminutive function generator 350, the predictive analysis application 360, the real-time tier generator 370, and the interaction identification application 380 may store the data extracted or received from the entity system 200, the third party system 201, and the computing device system 400 in the data repository 390. In some embodiments, the network provisioning application 340, the diminutive function generator 350, the predictive analysis application 360, the real-time tier generator 370, and the interaction identification application 380 may be a part of a single application.

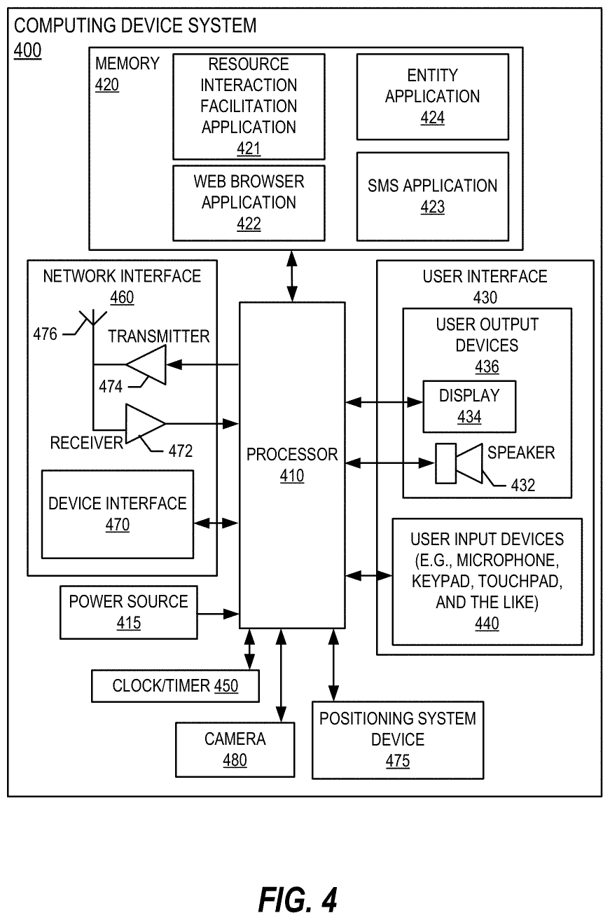

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a resource interaction facilitation application 421, entity application 424. These applications also typically instructions to a graphical user interface (GUI) on the display 430 that allows the user 110 to interact with the entity system 200, the resource interaction facilitation system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the resource interaction facilitation application 421 provided by the resource interaction facilitation system 300 allows the user 110 to access the resource interaction facilitation system 300. In some embodiments, the entity application 424 provided by the entity system 200. In some embodiments, the entity application 424 may be an online banking application. In such embodiment, the online banking application may provide a user interface that provides life plan features to the user, where by selecting life plan feature, the user may establish goals associated with life priorities or life events. In some embodiments, the resource interaction facilitation application 421 allow the user 110 to access the functionalities provided by the resource interaction facilitation system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

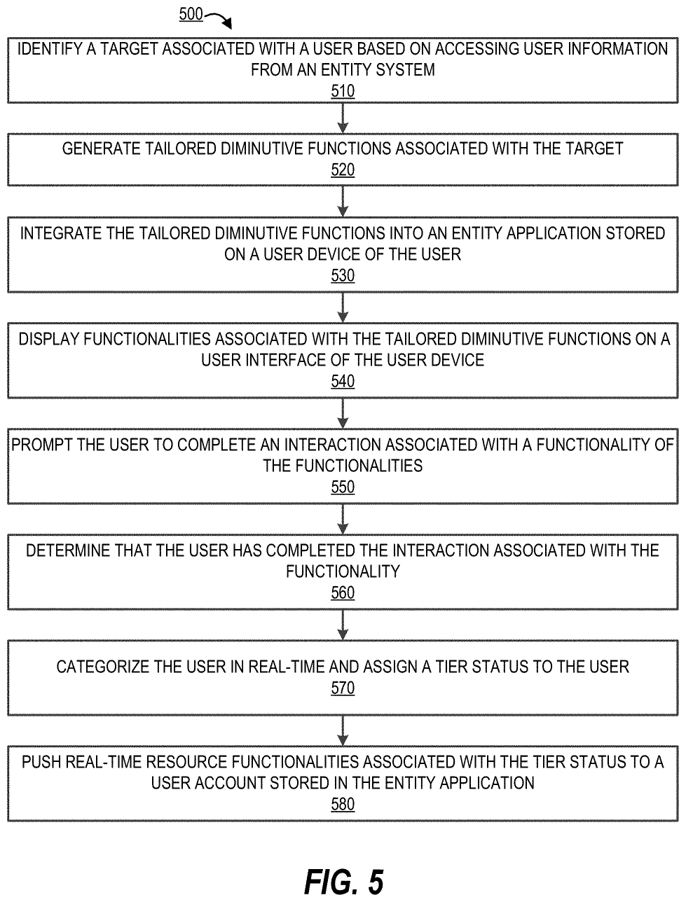

FIG. 5 provides a flowchart illustrating a process flow for generating tailored diminutive functions to facilitate resource interactions, in accordance with an embodiment of the invention.

As shown in block 510, the system identifies a target associated with a user based on accessing user information from an entity system. In some embodiments, the system may identify more than one target associated with the user. The target may be a goal associated with a life event or a life priority of the user. For example, target may be to buy a house. In another example, target of the user may be to buy a car. In another example, target may be saving towards a travel plan. The life priorities and life events may be stored in a database of the entity system associated with a user. In some embodiments, the goals associated with the life priorities and/or life events may be set by the user. In some embodiments, the system automatically identifies the goals associated with the life priorities and/or life events of the user. In some embodiments, the goals associated with the life priorities and/or life events may be suggested by the system based on other user data. For example, the system may suggest saving towards a house based on goals set by users who are similar to the user.

As shown in block 520, the system generates tailored diminutive functions associated with the target. Tailored diminutive functions may be related to functionalities (e.g., mini-missions) that the system generates to help the user engage and achieve the target quickly and efficiently. Functionality or a mini-mission may be a group of interactions (e.g., user actions) that help the user achieve the target faster. In an exemplary embodiment, where the target is buying a house, the system generates a first mini-mission that may comprise attending a seminar related to purchase of a house, creating an account in a real estate website, and/or the like. The system may further generate a second mini-mission that comprises visiting an open house, saving $X per week, or the like. Tailored diminutive function may be a piece of code that the system generates to integrate the mini-missions into the entity application of the user and to display the mini-missions to the user. In some embodiments, the tailored diminutive functions may be specific to each user. In some embodiments, the tailored diminutive functions may be specific to a group of users having similar characteristics (e.g., same groups, same location, same profession, or the like).

The system generates tailored diminutive functions based on the internal data stored in the entity system and/or external data from the third party systems. Internal data may be user personal data, resource data (e.g., transaction data), data associated with user groups or the like. External data may be third party data provided by any of the third party systems. In some embodiments, the third party systems may be any organizations that provide goods, products, or services to the user. In an exemplary embodiment, where the user is saving towards buying a house, the system may collect information associated with open houses near the location of the user from a third party system. The system may then generate a tailored diminutive function that displays on a user interface of the user device, the open houses and a mini-mission of visiting the displayed open houses. In some embodiments, the system may use predictive analysis to generate mini-missions and tailored diminutive functions associated with the mini-missions.

In some embodiments, the system generates the tailored diminutive functions based on the associate data. Associate may be an employee of the user. For example, an associate may be a financial advisor. In an exemplary embodiment, a financial advisor of an entity may suggest conducting a seminar relating to purchase of house and may invite users who are associated with the target of saving towards the purchase of a house. In such embodiment, the system may set “attending the seminar” as an interaction and generates a tailored diminutive function associated with the interaction of attending the seminar.

As shown in block 530, the system integrates the tailored diminutive functions into an entity application stored on a user device of the user. The system integrates the tailored diminutive functions associated with the entity application which allows the user to view the mini-missions and other data related to the mini-missions. In some embodiments, the tailored diminutive functions may also allow the user to track the progress of the mini-missions. For example, the system may integrate the tailored diminutive function generated by the system into the online banking application of the user, which allows the user to look at the progress of each of the mini-missions and targets.

As shown in block 540, the system displays functionalities associated with the tailored diminutive functions on a user interface of the user device. In response to integrating the tailored diminutive functions, the system causes the entity application to display the functionalities associated with the tailored diminutive functions. In some embodiments, the tailored diminutive function may cause the entity application to display the mini-mission by one or more gaming means, where gaming means may be animation, interactive games that utilize interaction gestures such as tap, drag, drag, press, flick, pinch, spread, and/or the like. For example, the system may display mini-missions using interactive games and the system may further allow the user to make changes to the mini-missions or allow the user to notify the system of completion of the mini-missions using interaction gestures.

As shown in block 550, the system prompts the user to complete an interaction associated with a functionality of the functionalities. The system causes the entity application to prompt the user to complete the interactions associated with a mini-mission that is related to a target. For example, in response to integrating a tailored diminutive function associated with the interaction of attending a seminar related to purchase of a house, the system may cause the entity application to prompt the user to attend the seminar. In some embodiments, the system in response to prompting the user to complete the interaction, may monitor user activity via the entity application in the user device.

As shown in block 560, the system determines that the user has completed the interaction associated with the functionality. In some embodiments, the system may automatically determine that the user has completed the interaction associated with the functionality. Continuing with the previous example, the system may identify that the user has joined the seminar based on the user device data (e.g., GPS data of the user device) of the user and determines that the user has attended the seminar. In another example, where the tailored diminutive function is associated with attending a webinar, the system may identify, based on the user device data, that the user has clicked on a link associated with the webinar and determines that the user has completed the interaction associated with the functionality.

In some embodiments, the system may allow the user to indicate completion of an interaction via the one or more gaming means. For example, after completing an interaction, the user may play an interactive game associated with the interaction and let the system know about completing the interaction. In some embodiments, the one or more gaming means may allow the user to indicate the progress of the interaction. For example, the system may present the interaction to the user in the form of an interactive game and the user may play the game using the interaction gestures to mark the progress of the interaction.

As shown in block 570, the system categorizes the user in real-time and assign a tier status to the user. In response to determining that the user has completed a first interaction associated with a mini-mission, the system assigns a tier-1 status to the user. The system may upgrade the tier status of the user based on identifying that the user has completed all interactions associated with the mini-mission. In some embodiments, the system may upgrade the tier status of the user based on identifying that the user has completed two interactions associated with the mini-mission. In some embodiments, upon completion of the interaction, the system may transform the graphical user interface of the user device to display rewards based on the progress of an interaction associated with a mini-mission and/or the mini-mission.

As shown in block 580, the system pushes real-time resource functionalities associated with the tier status to a user account stored in the entity application. Based on the tier status of the user, after completion of each interaction associated with the mini-mission, the system pushes resource functionalities (e.g., discounts, perks) to the user. For example, the system may identify that the user has attended a webinar related to the purchase of a house and may award discount points associated with financing of the house. In some embodiments, the systems dynamically pushes the real-time resource functionalities to the user device based on monitoring user activity. For example, the system may identify that user has walked into a merchant location, the system may dynamically present a discount associated with the merchant, where the discount is based on the tier-status of the user.

In some embodiments, the system may identify that the user has completed all interactions associated with a mini-mission and may generate new tailored diminutive functions associated with new interactions related to the mini-mission. Providing additional information, additional interactions, or additional mini-missions may be based on the responsiveness of the user. For example, the system may identify that the user has completed all the mini-missions, clicked on additional pieces of information presented by the system, and searched for additional information regarding the target, the system dynamically generates additional mini-missions upon determining that the user is responsive. In some embodiments, the system may identify that the user has completed all interactions associated with a mini-mission and may provide additional information associated with the target to the user. In some embodiments, the system may also display additional information associated with each target based on the external data. For example, the system may identify that the user is considering to buy a house in either of two locations and may intelligently identify pros and cons associated with each of the two locations and may present the information to the user. In some embodiments, the system integrates with features of the entity application to gather information associated with the mini-missions of the user. For example, the system may utilize an artificial intelligence of the entity application to gather information associated with user actions and/or intentions. In another example, the system may utilize a voice recognition feature of the entity application after receiving user permission to gather information associated with user actions and/or intentions.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for generating tailored diminutive functions to facilitate resource interactions, the system comprising:
at least one network communication interface;
at least one non-transitory storage device; and
at least one processing device coupled to the at least one non-transitory storage device and the at least one network communication interface, wherein the at least one processing device is configured to:
identify a target associated with a user based on accessing user information from an entity system;
establish communication link with one or more third party systems, wherein the one or more third party systems provide at least one of products, services, and goods associated with the target;
extract external data associated with the target from the one or more third party systems;
extract internal data associated with the target from the entity system;
extract associate data associated with the target from the entity system;
generate tailored diminutive functions associated with the target based on the external data, the internal data, and the associate data; and
integrate the tailored diminutive functions into an entity application stored on a user device of the user.

2. The system of claim 1, wherein in response to integrating the tailored diminutive functions into the entity application, the at least one processing device is configured to cause the entity application to:
display functionalities associated with the tailored diminutive functions on a user interface of the user device; and
prompt the user to complete an interaction associated with a functionality of the functionalities.

3. The system of claim 2, wherein the at least one processing device is configured to:
determine that the user has completed the interaction associated with the functionality; and
cause the entity application to prompt the user to complete at least one other interaction associated with the functionality.

4. The system of claim 3, wherein the at least one processing device is configured to:
in response to determining that the user has completed the at least one interaction, categorize the user in real-time and assign a tier status to the user; and
push real-time resource functionalities associated with the tier status to a user account stored in the entity application.

5. The system of claim 2, wherein the at least one processing device is configured to:
determine that the user has completed all interactions associated with the functionalities;
generate new tailored diminutive functions associated with the target; and
integrate the new tailored diminutive functions into the entity application.

6. The system of claim 1, wherein generating the tailored diminutive functions comprises:
retrieving resource data associated with the user from the entity system;
retrieving third party data associated with the user; and
formulating diminutive functions based on predictive analysis.

7. The system of claim 6, wherein generating the tailored diminutive functions is based on an input received from an associate.

8. The system of claim 4, wherein the target is associated with an event or a priority of the user.

9. A computer program product for generating tailored diminutive functions to facilitate resource interactions, the computer program product comprising a non-transitory computer-readable storage medium having computer executable instructions for causing a computer processor to perform the steps of:
identifying a target associated with a user based on accessing user information from an entity system;
establishing communication link with one or more third party systems, wherein the one or more third party systems provide at least one of products, services, and goods associated with the target;
extracting external data associated with the target from the one or more third party systems;
extracting internal data associated with the target from the entity system;
extracting associate data associated with the target from the entity system;
generating tailored diminutive functions associated with the target based on the external data, the internal data, and the associate data; and
integrating the tailored diminutive functions into an entity application stored on a user device of the user.

10. The computer program product of claim 9, wherein in response to integrating the tailored diminutive functions into the entity application, the computer executable instructions computer executable instructions cause a computer processor to perform the steps of causing the entity application to:
display functionalities associated with the tailored diminutive functions on a user interface of the user device; and
prompt the user to complete an interaction associated with a functionality of the functionalities.

11. The computer program product of claim 10, wherein the computer executable instructions for causing a computer processor to perform the steps of:
determining that the user has completed the interaction associated with the functionality; and
prompting the user to complete at least one other interaction associated with the functionality.

12. The computer program product of claim 11, wherein the computer executable instructions for causing a computer processor to perform the steps of:
in response to determining that the user has completed the at least one interaction, categorizing the user in real-time and assigning a tier status to the user; and
pushing real-time resource functionalities associated with the tier status to a user account stored in the entity application.

13. The computer program product of claim 10, wherein the computer executable instructions for causing a computer processor to perform the steps of:
determining that the user has completed all interactions associated with the functionalities;
generating new tailored diminutive functions associated with the target; and
integrating the new tailored diminutive functions into the entity application.

14. The computer program product of claim 9, wherein generating the tailored diminutive functions comprises:
retrieving resource data associated with the user from the entity system;
retrieving third party data associated with the user; and
formulating diminutive functions based on predictive analysis.

15. A computer implemented method for generating tailored diminutive functions to facilitate resource interactions, the method comprising:
identifying a target associated with a user based on accessing user information from an entity system;
establishing communication link with one or more third party systems, wherein the one or more third party systems provide at least one of products, services, and goods associated with the target;
extracting external data associated with the target from the one or more third party systems;
extracting internal data associated with the target from the entity system;
extracting associate data associated with the target from the entity system;
generating tailored diminutive functions associated with the target based on the external data, the internal data, and the associate data; and
integrating the tailored diminutive functions into an entity application stored on a user device of the user.

16. The computer implemented method of claim 15, wherein the method further comprises causing the entity application to:
display functionalities associated with the tailored diminutive functions on a user interface of the user device; and
cause the entity application to prompt the user to complete an interaction associated with a functionality of the functionalities.

17. The computer implemented method of claim 16, wherein the method further comprises:
determining that the user has completed the interaction associated with the functionality; and
prompting the user to complete at least one other interaction associated with the functionality.

18. The computer implemented method of claim 17, wherein the method further comprises:
in response to determining that the user has completed the at least one interaction, categorizing the user in real-time and assigning a tier status to the user; and
pushing real-time resource functionalities associated with the tier status to a user account stored in the entity application.

19. The computer implemented method of claim 16, wherein the method further comprises:
determining that the user has completed all interactions associated with the functionalities;
generating new tailored diminutive functions associated with the target; and
integrating the new tailored diminutive functions into the entity application.

20. The computer implemented method of claim 15, wherein generating the tailored diminutive functions comprises:
retrieving resource data associated with the user from the entity system;
retrieving third party data associated with the user; and
formulating diminutive functions based on predictive analysis.
